(19) United States
(12) Patent Application Publication
(10) Pub. No.: US 2026/0135616 A1
(43) Pub. Date: May 14, 2026

(54) OPTICAL TRANSMISSION DEVICE AND OPTICAL TRANSMISSION SYSTEM

(71) Applicant: 1FINITY Inc., Kawasaki-shi (JP)

(72) Inventor: Yoshito KACHITA, Kawasaki (JP)

(73) Assignee: 1FINITY Inc., Kawasaki-shi (JP)

(21) Appl. No.: 19/328,814

(22) Filed: Sep. 15, 2025

(30) Foreign Application Priority Data
Sep. 20, 2024 (JP) 2024-164090

(51) Int. Cl. H04B 10/071; H04B 10/079

(52) U.S. Cl. CPC H04B 10/071; H04B 10/07955

(57) ABSTRACT

Provided is an optical transmission device facing another optical transmission device via a transmission line having a predetermined transmission line loss. The optical transmission device includes a first transceiver that transmits first measurement light based on an optical time domain reflectometer (OTDR) to the transmission line and receives first return light based on reflection of the first measurement light from the transmission line, a measurer that measures a first optical loss in the transmission line based on the first measurement light and the first return light, a receiver that receives predetermined information related to a second optical loss in the transmission line from the another optical transmission device, and a calculator that calculates an inter-device distance between the optical transmission device and the another optical transmission device based on the first optical loss, the second optical loss, and the transmission line loss.

### CROSS-REFERENCE TO RELATED APPLICATION

This application is based upon and claims the benefit of priority of Japanese Patent Application No. 2024-164090 filed on Sep. 20, 2024, the entire contents of which are incorporated herein by reference.

### FIELD

A certain aspect of the present embodiments relates to an optical transmission device and an optical transmission system.

### BACKGROUND

There has been known an OTDR (Optical Time Domain Reflectometer) including a laser light source that emits a laser beam into a device under test and a connection port for connecting to an end of the device under test. It is also known that an OTDR works with another OTDR to measure the fiber length of an optical fiber (see, for example, U.S. Patent Application Publication No. 2021/0181060).

### SUMMARY

According to an aspect of the present disclosure, there is provided an optical transmission device facing another optical transmission device via a transmission line having a predetermined transmission line loss. The optical transmission device includes a first transceiver that transmits first measurement light based on an optical time domain reflectometer (OTDR) to the transmission line and receives first return light based on reflection of the first measurement light from the transmission line; a measurer that measures a first optical loss in the transmission line based on the first measurement light and the first return light; a receiver that receives predetermined information related to a second optical loss in the transmission line from the another optical transmission device; and a calculator that calculates an inter-device distance between the optical transmission device and the another optical transmission device based on the first optical loss, the second optical loss, and the transmission line loss.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 is a block diagram illustrating an example of an optical transmission system.

FIG. 2 is a flowchart illustrating an example of the operation of the optical transmission system.

FIG. 3A illustrates an example of a U/D loss distribution.

FIG. 3B illustrates an example of a D/U loss distribution.

FIG. 4 is a diagram for explaining an example of conversion of a U/D loss distribution.

FIG. 5A illustrates an example of calculation of a distance #1.

FIG. 5B illustrates an example of calculation of a distance #2.

### DETAILED DESCRIPTION

However, when a distance between optical transmission devices facing each other via a transmission line such as an optical fiber is measured by an OTDR mounted on the optical transmission device, the measurement of the distance may be difficult. For example, in a case where the distance between the optical transmission devices is long, even if the measurement light based on the OTDR is input to the transmission line, if the optical power of the measurement light is reduced to the limit of the measurement sensitivity or less, there is a concern that the distance cannot be measured over the entire length.

Therefore, according to one aspect, it is an object to provide an optical transmission device and an optical transmission system that measure a distance between optical transmission devices using an OTDR when the distance between the optical transmission devices is long.

Hereinafter, embodiments of the present invention will be described with reference to the drawings.

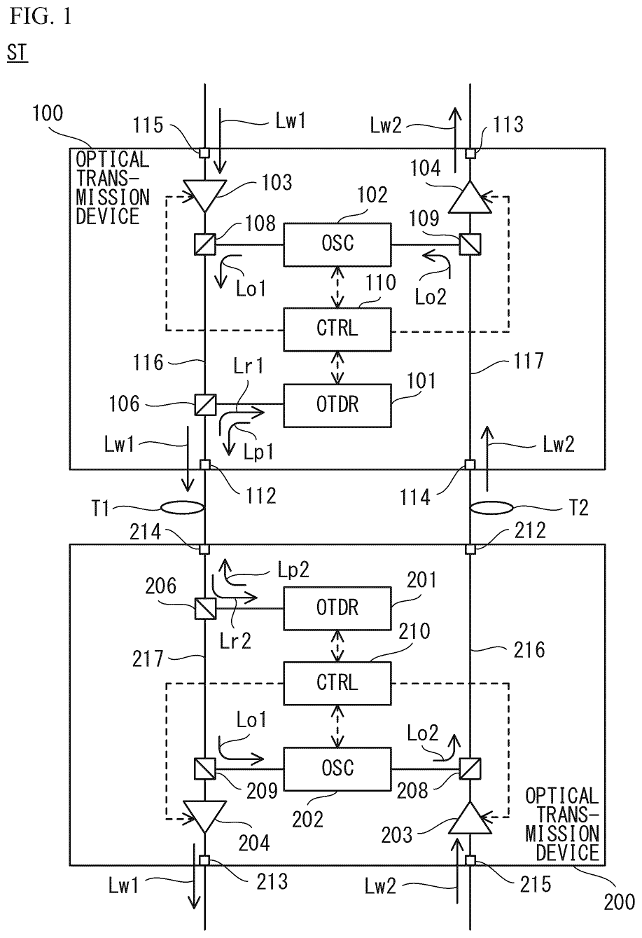

As illustrated in FIG. 1, an optical transmission system ST includes two optical transmission devices 100 and 200 facing each other. The optical transmission device 100 is an example of a first optical transmission device. The optical transmission device 200 is an example of a second optical transmission device. Each of the optical transmission device 100 and 200 includes, for example, a reconfigurable optical add/drop multiplexer (ROADM).

The optical transmission devices 100 and 200 are connected to each other via two parallel transmission lines T1 and T2. The optical transmission device 100 is connected to one end of each of the transmission lines T1 and T2. The optical transmission device 200 is connected to the other end of each of the transmission lines T1 and T2. Each of the transmission lines T1 and T2 includes an optical fiber. The type of the optical fiber is not particularly limited. The optical fiber may be a single mode fiber (SMF) or a dispersion shifted fiber (DSF). Each of the transmission lines T1 and T2 have a predetermined transmission line loss.

First, the optical transmission device 100 will be described. The optical transmission device 100 includes an OTDR (Optical Time Domain Reflectometer) unit 101, an OSC transceiver 102, and optical amplifiers 103 and 104. The OTDR unit 101 is an example of a first transceiver and a measurer. The OSC transceiver 102 is an example of a second transceiver.

The optical transmission device 100 includes WDM couplers 106 and 108, a branching coupler 109, a controller 110 (denoted by CTRL in FIG. 1), optical transmitters 112 and 113, and optical receivers 114 and 115. The controller 110 is an example of a receiver and a calculator. Each of the optical transmitters 112 and 113 and the optical receivers 114 and 115 includes a connector.

The optical amplifier 103, the WDM couplers 106 and 108, the optical transmitter 112, and the optical receiver 115 are connected by an optical fiber 116 of the optical transmission device 100. The optical amplifier 104, the branching coupler 109, the optical transmitter 113, and the optical receiver 114 are connected by an optical fiber 117 of the optical transmission device 100.

The OTDR unit 101 is optically connected to the WDM coupler 106. The OTDR unit 101 transmits pulse light Lp1 as first measurement light to the transmission line T1 via the optical fibers 116, and receives return light Lr1 as first return light based on reflection of the pulse light Lp1. The reflection includes, for example, Rayleigh scattering, Fresnel reflection, and the like. The OTDR unit 101 can generate a loss distribution representing a distribution of optical loss in the longitudinal direction of the transmission line T1 by receiving the return light Lr1. In this way, the OTDR unit 101 can measure the magnitude of the optical loss in the transmission line T1.

The OSC transceiver 102 is optically connected to the WDM coupler 108 and the branching coupler 109. The OSC transceiver 102 transmits first control signal light Lo1 based on an optical supervisory channel (OSC) toward the optical transmission device 200. The first control signal light Lo1 is an example of first signal light. The OSC transceiver 102 receives second control signal light Lo2 output from the optical transmission device 200. The second control signal light Lo2 is an example of second signal light. The second control signal light Lo2 may or may not include a span loss as transmission line loss of the transmission line T1.

The optical amplifier 103 amplifies and outputs WDM signal light Lw1 received by the optical transmission device 100 via the optical receiver 115. The optical amplifier 103 is a post-amplifier realized by, for example, an erbium doped fiber amplifier (EDFA) and a circuit substrate that controls the gain of the EDFA. The post-amplifier is an amplifier provided in a subsequent stage or downstream of a wavelength selective switch (WSS) (not illustrated) provided between the optical amplifier 103 and the optical receiver 115. The WDM signal light Lw1 output from the optical amplifier 103 is transmitted to the transmission line T1 via the optical transmitter 112.

The optical amplifier 104 amplifies and outputs WDM signal light Lw2 received by the optical transmission device 100 via the optical receiver 114. The optical amplifier 104 is a preamplifier realized by, for example, an EDFA and a circuit substrate that controls the gain of the EDFA. The preamplifier is an amplifier provided in a front stage or upstream of a WSS (not illustrated) provided between the optical amplifier 104 and the optical transmitter 113. The WDM signal light Lw2 output from the optical amplifier 104 is transmitted via the optical transmitter 113.

The controller 110 is electrically connected to the OTDR unit 101, the OSC transceiver 102, and the optical amplifiers 103 and 104. The controller 110 includes a processor such as a central processing unit (CPU) and a memory such as a random access memory (RAM) or a read only memory (ROM). The controller 110 may include a field programmable gate array (FPGA) or an application specific integrated circuit (ASIC). The controller 110 controls the operations of the OTDR unit 101, the OSC transceiver 102, and the optical amplifiers 103 and 104.

For example, the controller 110 can request the OTDR unit 101 to output the pulsed light Lp1. The controller 110 may request the OSC transceiver 102 to output the first control signal light Lo1. The controller 110 can adjust the gain of the optical amplifiers 103 and 104.

Next, the optical transmission device 200 will be described. The optical transmission device 200 includes an OTDR unit 201, an OSC transceiver 202, and optical amplifiers 203 and 204. The optical transmission device 200 includes WDM couplers 206 and 208, a branching coupler 209, a controller 210, optical transmitters 212 and 213, and optical receivers 214 and 215.

The optical amplifier 203, the WDM coupler 208, the optical transmitter 212, and the optical receiver 215 are connected by an optical fiber 216 of the optical transmission device 200. The optical amplifier 204, the WDM coupler 206, the branching coupler 209, the optical transmitter 213, and the optical receiver 214 are connected by an optical fiber 217 of the optical transmission device 200.

As described above, the optical transmission device 200 basically has the same configuration as that of the optical transmission device 100. Therefore, the details of the optical transmission device 200 are omitted. For example, the OTDR unit 201 transmits the pulse light Lp2 as second measurement light to the transmission line T1 via the optical fibers 217, and receives return light Lr2 as second return light based on the reflection of the pulse light Lp2. The OSC transceiver 202 outputs the second control signal light Lo2 based on the OSC toward the optical transmission device 100. The optical transmitter 212 transmits the second control signal light Lo2 toward the optical transmission device 100. Accordingly, the second control signal light Lo2 propagates through the transmission line T2.

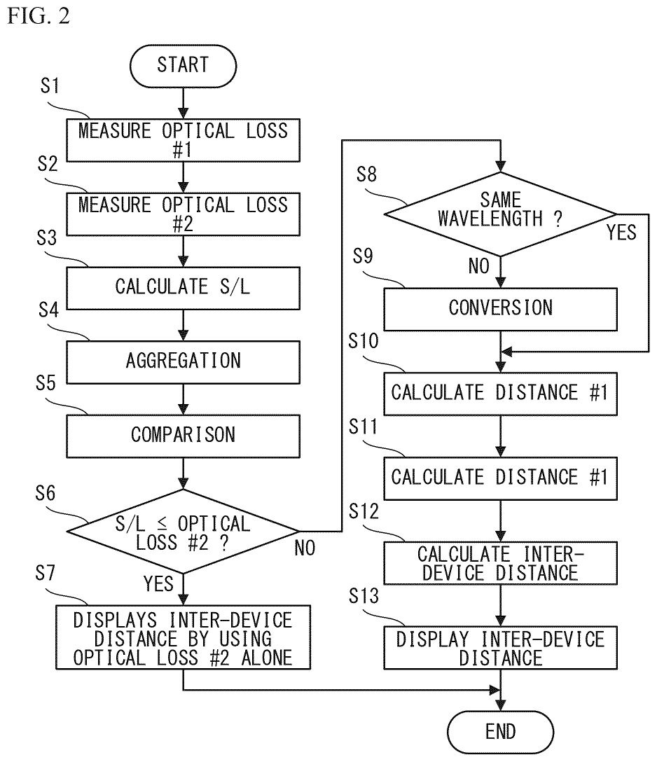

The operation of the optical transmission system ST will be described with reference to FIGS. 2 to 5B.

First, as illustrated in FIG. 2, the OTDR unit 101 of the optical transmission device 100 measures an optical loss #1 of the transmission line T1 (step S1). The optical loss #1 is an example of a first optical loss. More specifically, the OTDR unit 101 transmits the pulse light Lp1 having a wavelength λ1 to the transmission line T1, and receives the return light Lr1 having the wavelength λ1 from the transmission line T1.

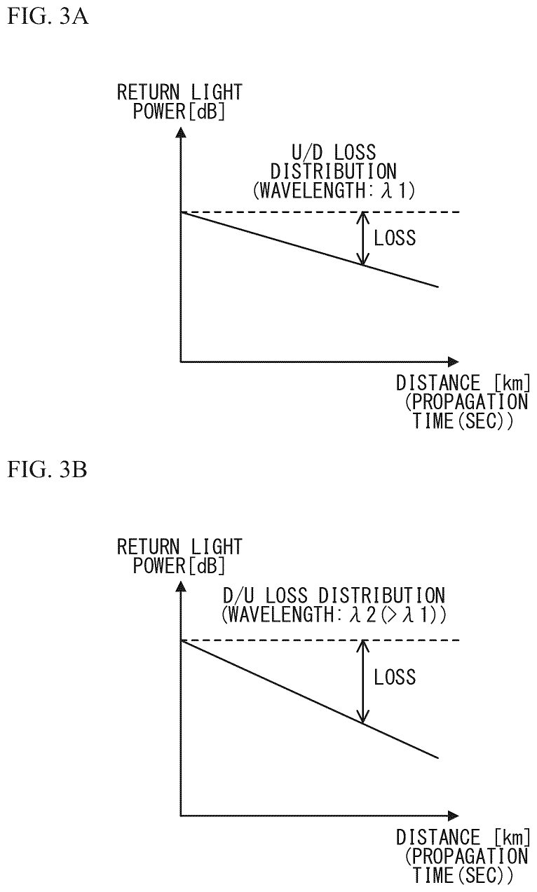

That is, the OTDR unit 101 receives the return light Lr1 of the pulse light Lp1 transmitted from the optical transmission device 100 disposed upstream of the transmission line T1 toward the optical transmission device 200 disposed downstream of the transmission line T1. The OTDR unit 101 measures the magnitude of the optical loss #1 in the transmission line T1 based on the pulse light Lp1 and the return light Lr1. As a result, as illustrated in FIG. 3A, the OTDR unit 101 can generate an upstream/downstream (U/D) loss distribution including the optical loss #1 when the pulse light Lp1 having the wave length λ1 is transmitted from the upstream to the downstream. Such a U/D loss distribution corresponding to the wavelength λ1 is an example of a first optical loss.

When the optical loss #1 is measured, the OTDR unit 201 of the optical transmission device 200 measures an optical loss #2 of the transmission line T1 (step S2). The optical loss #2 is an example of a second optical loss. More specifically, the OTDR unit 201 transmits the pulse light Lp2 as the second measurement light having the wave length λ2 longer than the wave length λ1 to the transmission line T1, and receives the return light Lr2 as the second return light from the transmission line T1.

That is, the OTDR unit 201 receives the return light Lr2 of the pulse light Lp2 transmitted from the optical transmission device 200 toward the optical transmission device 100. The OTDR unit 201 measures the magnitude of the optical loss #2 in the transmission line T1 based on the pulse light Lp2 and the return light Lr2. As a result, as illustrated in FIG. 3B, the OTDR unit 201 can generate a downstream/upstream (D/U) loss distribution including the optical loss #2 in a case where the pulse light Lp2 having the wavelengths λ2 is transmitted from the downstream to the upstream. Such a D/U loss distribution corresponding to the wavelength λ2 is an example of a second optical loss.

When the optical loss #2 is measured, the controller 110 calculates a span loss (denoted as S/L in FIG. 2) (step S3). More specifically, the controller 110 requests the OSC transceiver 102 to transmit the first control signal light Lo1. Thus, the OSC transceiver 102 transmits the first control signal light Lo1. The first control signal light Lo1 propagates through the transmission line T1 and reaches the optical transmission device 200.

The OSC transceiver 202 of the optical transmission device 200 receives the first control signal light Lo1. When the OSC transceiver 202 receives the first control signal light Lo1, the controller 210 measures the optical power of the first control signal light Lo1 as reception optical power, and requests the OSC transceiver 202 to transmit the second control signal light Lo2 including the reception optical power. Accordingly, the OSC transceiver 202 transmits the second control signal light Lo2. The second control signal light Lo2 propagates through the transmission line T2 and reaches the optical transmission device 100.

The OSC transceiver 102 of the optical transmission device 100 receives the second control signal light Lo2. When the OSC transceiver 102 receives the second control signal light Lo2, the controller 110 calculates the span loss based on a difference between the transmission optical power of the first control signal light Lo1 and the reception optical power included in the second control signal light Lo2.

Note that, in a case where the span loss of the transmission line T1 is specified in advance by specifications or the like, the process of step S3 may be omitted. In this case, the controller 110 may hold the span loss of the transmission line T1 in advance. The OSC transceiver 102 may transmit the first control signal light Lo1 including the transmission light power of the first control signal light Lo1. In this case, when the OSC transceiver 202 receives the first control signal light Lo1, the controller 210 may calculate the span loss based on a difference between the transmission optical power included in the first control signal light Lo1 and the reception optical power of the first control signal light Lo1. Further, the controller 210 may calculate the span loss based on not only such a difference but also a difference between the transmission light power and the reception light power of the WDM signal light Lw1 when the WDM signal light Lw1 is communicated, for example.

When the span loss is calculated, the controller 110 aggregates the optical loss #2 measured by the OTDR unit 201 into the optical transmission device 100 (step S4). For example, when the span loss is calculated, the controller 110 requests the OSC transceiver 102 to transmit the first control signal light Lo1 that requests transmission of the optical loss #2. Thus, the OSC transceiver 102 transmits the first control signal light Lo1.

The OSC transceiver 202 of the optical transmission device 200 receives the first control signal light Lo1. When the OSC transceiver 202 receives the first control signal light Lo1, the controller 210 requests the OSC transceiver 202 to transmit the second control signal light Lo2 including the optical loss #2. Accordingly, the OSC transceiver 202 transmits the second control signal light Lo2 including the optical loss #2. When the controller 210 calculates the span loss, the OSC transceiver 202 may transmit the second control signal light Lo2 including the optical loss #2 and the span loss.

The OSC transceiver 102 of the optical transmission device 100 receives the second control signal light Lo2. When receiving the second control signal light Lo2, the OSC transceiver 102 converts the second control signal light Lo2 into electrical control information. The control information is an example of predetermined information. When the OSC transceiver 102 converts the second control signal light Lo2 into the control information, the OSC transceiver 102 transmits the control information to the controller 110. Accordingly, the controller 110 receives the control information related to the optical loss #2 from the optical transmission device 200. That is, as a result, the controller 110 aggregates the optical loss #2 measured by the OTDR unit 201 into the optical transmission device 100. Instead of such aggregation, the controller 210 may aggregate the optical loss #1 measured by the OTDR unit 101 into the optical transmission device 200.

After the aggregation, the controller 110 compares the span loss with the optical loss #2 (step S5), and determines whether the span loss is equal to or less than the optical loss #2 (step S6). More specifically, when the controller 110 receives the control information, the controller 110 can calculate the optical loss #2 based on the control information. When the optical loss #2 is calculated, the controller 110 determines whether the span loss corresponding to the wavelength λ2 is equal to or less than the total loss of the optical loss #2. When the span loss is equal to or less than the optical loss #2 (step S6: YES), the controller 110 displays an inter-device distance by using the optical loss #2 alone (step S7), and ends the process.

More specifically, the controller 110 displays the distance of the transmission line T1 by using the optical loss #2 alone on a display device connected to the optical transmission device 100, and ends the process. In this way, if the span loss of the transmission line T1 is equal to or less than the optical loss #2, the controller 110 can measure the inter-device distance between the optical transmission devices 100 and 200 over the entire length.

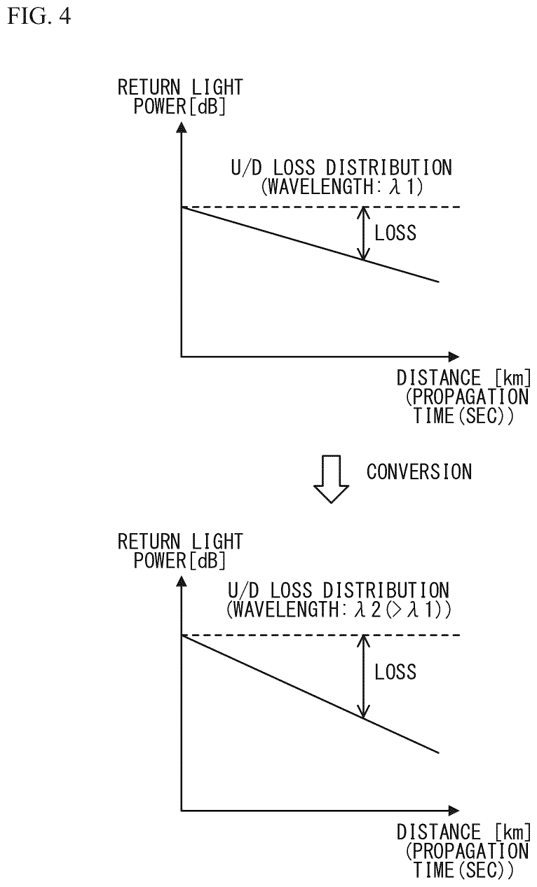

On the other hand, when the span loss is larger than the optical loss #2 (step S6: NO), the controller 110 determines whether the pulse light Lp1 and the pulse light Lp2 have the same wavelengths (step S8). If the wavelengths are not the same as each other (step S8: NO), the controller 110 converts either the U/D loss distribution or the D/U loss distribution (step S9). For example, as illustrated in FIG. 4, the controller 110 converts the U/D loss distribution corresponding to the wavelength λ1 into the U/D loss distribution corresponding to the wavelength λ2. Such a U/D loss distribution corresponding to the wavelength λ2 is an example of a third optical loss. The controller 110 can convert the U/D loss distribution based on the ratio of the first loss coefficient corresponding to the pulse light Lp1 and the second loss coefficient corresponding to the pulse light Lp2.
Similarly, the controller 110 may convert the D/U loss distribution corresponding to the wavelength λ2 into the D/U loss distribution corresponding to the wavelength λ1. If the wavelengths are the same as each other (step S8: YES), the controller 110 skips the process of step S9. For example, if the controller 110 can confirm that the wavelengths of the pulse light Lp1 and Lp2 are the same as each other via a network controller connected to each of the optical transmission devices 100 and 200, the controller 110 can skip the process of step S9.

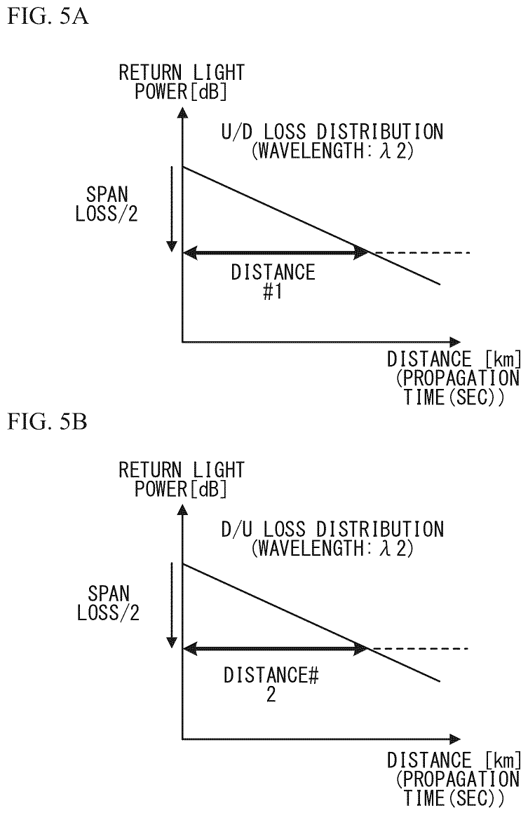

When either the U/D loss distribution or the D/U loss distribution is converted, the controller 110 calculates a distance #1 (step S10). The distance #1 is an example of a first distance. For example, as illustrated in FIG. 5A, the controller 110 calculates a half of the span loss corresponding to an intermediate position of the transmission line T1 and calculates the distances #1 corresponding to the half of the span loss, based on the U/D loss distribution corresponding to the wavelengths λ2. The intermediate position is an example of a specific position.

After calculating the distance #1, the controller 110 calculates a distance #2 (step S11). The distance #2 is an example of a second distance. For example, as illustrated in FIG. 5B, the controller 110 calculates one half of the span loss corresponding to the intermediate position of the transmission line T1 and calculates the distances #2 corresponding to one half of the span loss, based on the D/U loss distribution corresponding to the wavelengths λ2.

After calculating the distances #2, the controller 110 calculates the inter-device distance (step S12).

INTER-DEVICE DISTANCE=DISTANCE #1+DISTANCE #2 [Formula 1]

For example, as illustrated in Formula 1, the controller 110 calculates the inter-device distance by adding the distance #1 to the distance #2. As described above, when the wavelengths are not the same as each other, the controller 110 converts the U/D loss distribution corresponding to the wavelength λ1 into the U/D loss distribution corresponding to the wavelength λ2. Therefore, the distance #2 is added to the distance #1 calculated based on the U/D loss distribution corresponding to the wavelength λ2, so that the inter-device distance can be calculated.

In this way, the controller 110 switches a calculation method for calculating the inter-device distance based on the comparison result between the span loss and the optical loss #2. When the inter-device distance is calculated, the controller 110 displays the inter-device distance (step S13), and ends the process.

As described above, the optical transmission device 100 includes the OTDR unit 101 and the controller 110. The OTDR unit 101 transmits the pulse light Lp1 having the wavelengths λ1 based on the OTDR to the transmission line T1, and receives the return light Lr1 having the wavelengths λ1 based on the reflection of the pulse light Lp1 from the transmission line T1. When receiving the return light Lr1, the OTDR unit 101 measures the optical loss #1 in the transmission line T1 based on the pulse light Lp1 and the return light Lr1, and generates the U/D loss distribution including the optical loss #1.

The controller 110 receives the control information related to the optical loss #2 in the transmission line T1 from the optical transmission device 200 via the second control signal light Lo2, and calculates the inter-device distance based on the optical loss #1, the optical loss #2, and the span loss. Accordingly, the distance between the optical transmission devices 100 and 200 can be measured by the OTDR regardless of the length of the distance. That is, even when the distance between the optical transmission devices 100 and 200 is increased, the distance between the optical transmission devices 100 and 200 can be measured using the OTDR.

In the above-described embodiment, the intermediate position of the transmission line T1 is described as an example of the specific position, but the specific position is not limited to the intermediate position. The specific position may be a position that is specified at a position corresponding to one third of the transmission line T1 from either position of the optical transmission devices 100 and 200. In this case, the controller 110 can calculate the inter-device distance by adding the distance #1 corresponding to one third of the span loss to the distance #2 corresponding to two thirds of the span loss. In this manner, the distance #1 and the distance #2 may be calculated by different calculation methods according to the ratio of the span loss.

The controller 110 may calculate a span latency in the transmission line T1 based on a light speed, the inter-device distance, a refractive index of the transmission line T1, and a predetermined calculation formula. The latency is an example of a propagation delay time. The predetermined calculation formula is defined by, for example, (optical loss #1×refractive index)/light speed+(optical loss #2×refractive index)/light speed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

For example, in the above-described embodiment, it has been described that the OSC transceiver 202 transmits the second control signal light Lo2 including the optical loss #2. However, if the optical transmission devices 100 and 200 are connected to a network controller that controls the optical transmission devices 100 and 200, the optical loss #2 may be transmitted from the optical transmission device 200 to the optical transmission device 100 via the network controller. That is, the optical loss #2 may be transmitted by electrical transmission instead of optical transmission.

What is claimed is:

1. An optical transmission device facing another optical transmission device via a transmission line having a predetermined transmission line loss, the optical transmission device comprising:
a first transceiver that transmits first measurement light based on an optical time domain reflectometer (OTDR) to the transmission line and receives first return light based on reflection of the first measurement light from the transmission line;
a measurer that measures a first optical loss in the transmission line based on the first measurement light and the first return light;
a receiver that receives predetermined information related to a second optical loss in the transmission line from the another optical transmission device; and
a calculator that calculates an inter-device distance between the optical transmission device and the another optical transmission device based on the first optical loss, the second optical loss, and the transmission line loss.

2. The optical transmission device according to claim 1,
wherein the calculator calculates a first distance from the optical transmission device to a specific position in the transmission line based on a part of the first optical loss, calculates a second distance from the another optical transmission device to the specific position based on a part of the second optical loss, and calculates the inter-device distance based on the first distance and the second distance.

3. The optical transmission device according to claim 1,
wherein the calculator switches a calculation method for calculating the inter-device distance based on a comparison result between the first optical loss or the second optical loss and the transmission line loss.

4. The optical transmission device according to claim 1,
wherein when the second optical loss is measured by the another optical transmission device based on second measurement light having a second wavelength different from a first wavelength of the first measurement light and second return light from the transmission line based on reflection of the second measurement light, the calculator converts the first optical loss into a third optical loss corresponding to the second wavelength based on a ratio of a first loss coefficient corresponding to the first measurement light and a second loss coefficient corresponding to the second measurement light, and calculates the inter-device distance based on the second optical loss, the third optical loss, and the transmission line loss.

5. The optical transmission device according to claim 1,
wherein the calculator calculates the second optical loss based on the predetermined information.

6. The optical transmission device according to claim 1, further comprising a second transceiver that transmits first signal light toward the another optical transmission device and receives second signal light including a reception light power of the first signal light received by the another optical transmission device,
wherein the calculator calculates the transmission line loss based on a difference between a transmission light power of the first signal light and the reception light power included in the second signal light.

7. The optical transmission device according to claim 1,
wherein the calculator calculates a specific propagation delay time in the transmission line based on a light speed, the inter-device distance, a refractive index of the transmission line, and a predetermined calculation formula for calculating a propagation delay time.

8. The optical transmission device according to claim 1,
wherein the optical transmission device is connected to one end of the transmission line, and the another optical transmission device is connected to another end of the transmission line.

9. An optical transmission system comprising:
a first optical transmission device and a second optical transmission device facing each other via a transmission line having a predetermined transmission line loss,
wherein the first optical transmission device transmits first measurement light based on an optical time domain reflectometer (OTDR) to the transmission line, receives first return light based on reflection of the first measurement light from the transmission line, and measures a first optical loss in the transmission line based on the first measurement light and the first return light,
wherein the second optical transmission device transmits second measurement light based on an OTDR to the transmission line, receives second return light based on reflection of the second measurement light from the transmission line, and measures a second optical loss in the transmission line based on the second measurement light and the second return light, and
wherein the first optical transmission device receives predetermined information related to the second optical loss from the second optical transmission device, and calculates an inter-device distance between the first optical transmission device and the second optical transmission device based on the first optical loss, the second optical loss, and the transmission line loss.
